(19) United States
(12) Patent Application Publication
(10) Pub. No.: US 2018/0142490 A1
(43) Pub. Date: May 24, 2018

(54) Pinned Monopole Splice Assembly and Methods

(71) Applicant: Glaus, Pyle, Schomer, Burns & DeHaven, Inc., Akron, OH (US)

(72) Inventor: Jashu Lee Eblen, Westfield (IN)

(21) Appl. No.: 15/455,098

(22) Filed: Mar. 9, 2017

Related U.S. Application Data
(60) Provisional application No. 62/305,623, filed on Mar. 9, 2016.

(51) Int. Cl. E04H 12/22; E04H 12/08

(52) U.S. Cl. CPC E04H 12/2292; H01Q 1/1242; E04H 12/08

(57) ABSTRACT

Systems and methods include plates of metal such as steel, interconnected to the side of a monopole tower to convey forces through pins, rather than large quantities of blind bolts. The systems and methods reduce: the number of holes that must be drilled in the tower; the total quantity of blind fasteners required on any particular project; total labor hours; at-height labor hours; and overall risk at the time of installation.

This application claims the benefit of U.S. Provisional Application No. 62/305,623 filed Mar. 9, 2016 entitled Pinned Monopole Splice Assembly and Methods.

### BACKGROUND

Communications towers have become ubiquitous, but demand for space on towers has increased faster than new towers can be erected. Existing towers often can accommodate the continuing demand for the physical space necessary to provide additional features, antennas, and the like, but existing towers may not be engineered for the additional weight or the increased profile that added features present to environmental forces, or in certain cases the existing structure may no longer comply with updated code requirements.

### BRIEF SUMMARY

Consequently, there is a need for methods and apparatus to reinforce existing towers, specifically but not necessarily limited to those in the telecommunications industry, for example those of the monopole design. Such remedial efforts may be directed toward stiffening existing towers in order to allow installation of larger, heavier tower-top equipment, as is common with a carrier's upgrade from 3G to 4G RF technologies and likely in the future as yet unknown upgrades are introduced.

In one embodiment, a system connects two large plates of steel together, and interconnects them to the side of a monopole tower. As more specifically described below one example is structured to convey forces through simple and inexpensive pins, rather than large quantities of very expensive “blind bolts.” Such pin connections minimize the number of holes that must be drilled in the tower, the total quantity of blind fasteners required on the entire project, reduced total labor hours required on the project, reduced at-height labor hours, and reduced overall risk at the time of installation.

The accompanying drawings, which are incorporated in and constitute a part of the specification, illustrate various example systems, methods, and so on that illustrates various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### BRIEF DESCRIPTION OF DRAWINGS

FIG. 1 is an exploded view of a pinned monopole splice kit and portion of a monopole to which the assembly is attached.

FIG. 2 is an exemplary view of the kit and monopole of FIG. 1 in an installed configuration.

### DETAILED DESCRIPTION

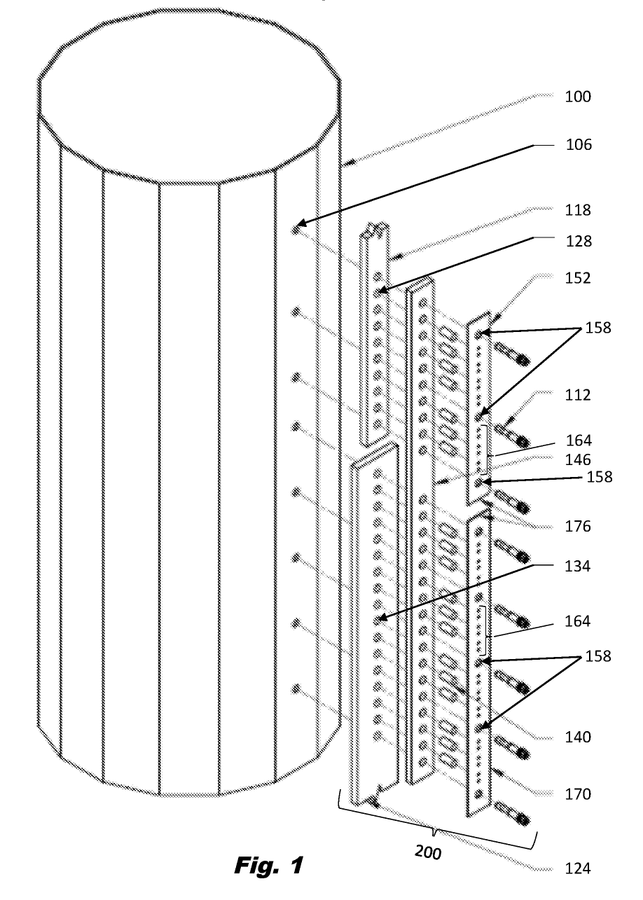

With reference to FIG. 1, a portion of an existing monopole 100 is shown with an exploded view of a splice kit 200. Monopole 100 includes a number of holes 106 drilled to accommodate commercially available one-sided bolts commonly called ‘blind bolts’ 112 as shown and discussed below, although it is appreciated that any connection mechanism to the existing monopole (e.g. threads, toggles, anchors and the like) may be substituted.

Reference 118 illustrates a portion of a reinforcement upper flat plate. Reference 124 illustrates a portion of a reinforcement lower flat plate. While the upper flat plate 118 and lower flat plate 124 are shown in different widths, in other embodiments they could be the same width or they could be swapped.

Reference 128 and 134 illustrate holes to accommodate a series of pins 140 and the bolts 112.

Reference 146 illustrates a splice plate configured to overlap both the reinforcement upper flat plate 118 and the reinforcement lower flat plate 124. The splice plate 146 includes a series of holes to accept the pins 140 and bolts 112 and is sized to convey sufficient structural loads appropriate for the application.

Reference 152 illustrates an upper cap plate including spaced holes 158 to accommodate the bolts 112 and a series of smaller inspection ports 164 between the spaced holes 158. Similarly reference 170 illustrates a lower cap plate including spaced holes 158 to accommodate the bolts 112 and a series of smaller inspection ports 164 between the spaced holes 158. Upper cap plate 152 may be spaced 176 from lower cap plate 170, as direct connection is not required.

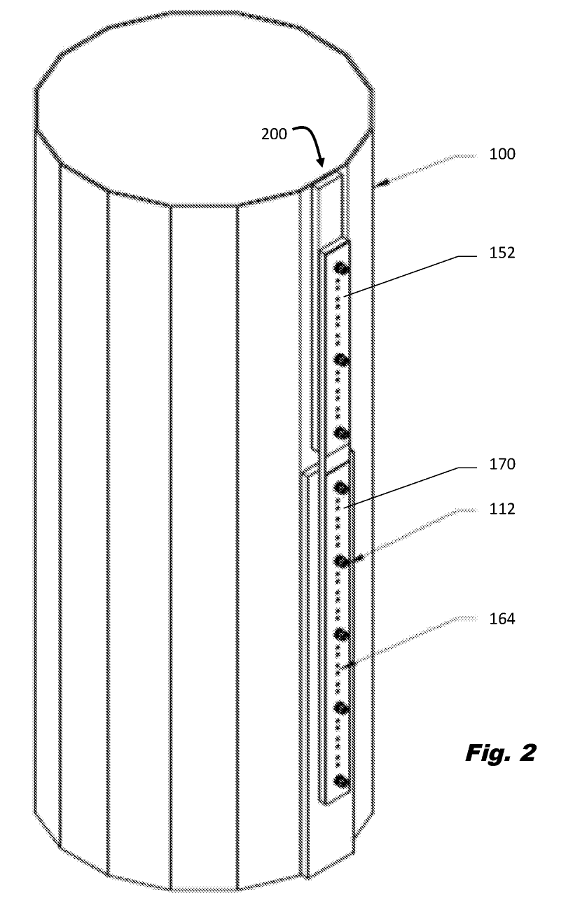

With reference now to FIG. 2, as assembled pinned monopole splice kit 200 is shown reinforcing a monopole 100. In the assembled state, pins (not shown) are contained by the upper cap plate 152 and lower cap plate 170 on one side of the assembly and by the monopole 100 on the other side of the assembly.

While the systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on provided herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

As used herein, “connection” or “connected” means both directly, that is, without other intervening elements or components, and indirectly, that is, with another component or components arranged between the items identified or described as being connected. To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Similarly, when the applicants intend to indicate “one and only one” of A, B, or C, the applicants will employ the phrase “one and only one”. Thus, use of the term “or” herein is the inclusive, and not the exclusive use. See, Bryan A. Garner, A Dictionary of Modern Legal Usage 624 (2d. Ed. 1995).

1. (canceled)

2. A method of reinforcing a tower structure, the method comprising:
Forming a plurality of holes at intervals in an exterior surface of the tower structure along a line parallel to an axis of the tower structure;
Aligning a first through hole in a first reinforcement member with at least one of the plurality of holes in the exterior surface of the tower structure, where the first reinforcement member further includes a plurality of retention holes spaced from the through hole;
Aligning a second through hole in a second reinforcement member with at least a second one of the plurality of holes in the exterior surface of the tower structure, where the second reinforcement member further includes a plurality of retention holes spaced from the through hole;
Overlapping a splice member over the first reinforcement member and the second reinforcement member, where splice member includes first and second through holes aligning with the first through hole and the second hole, and where the splice member further includes a plurality of retention holes aligning with the plurality of retention holes in the first reinforcement member and the second reinforcement member; and
Fixing pins into at least selected ones of the plurality of retention holes of the first and second reinforcement members and corresponding ones of the plurality of retention holes of the splice member.

3. The method as set forth in claim 2, further comprising mechanically connecting the splice member and at least one of the reinforcement members with the tower structure through at least one of the plurality of through holes in the splice member and a corresponding one of the plurality of through holes in the reinforcement member.

4. The method as set forth in claim 3, where the connecting comprises:
Inserting a bolt through at least one of the plurality of through holes in the splice member and a corresponding one of the plurality of through holes in the reinforcement member; and
Threading the bolt into one of the plurality of holes in the exterior surface of the tower structure.

5. The method as set forth in claim 2, where the fixing comprises installing a cap member over the splice member, where the cap member retains the pins in the plurality of retention holes.

6. The method as set forth in claim 5, further comprising mechanically connecting the cap member, the splice member and at least one of the reinforcement members with the tower structure through an aligned through hole in the cap member, at least one of the plurality of through holes in the splice member, a corresponding one of the plurality of through holes in the reinforcement member and one of the plurality of holes in the exterior surface of the tower structure.

7. A kit for reinforcing a tower structure, the kit comprising:
A plurality of reinforcement members each having a plurality of reinforcement interruptions through the reinforcement members where selected-ones of the plurality of reinforcement interruptions provide a template to form holes in an exterior surface of the tower structure along a line parallel to a vertical axis of the tower structure;
At least one splice member having a plurality of splice member interruptions through the splice member where the splice member interruptions align with the plurality of reinforcement interruptions, and non-adjacent ones of the plurality of splice member interruptions align with: (i) the selected ones of the plurality of reinforcement interruptions and (ii) holes formed in the exterior surface of the tower structure; and
A plurality of pins to be fixed into place in selected ones of the splice member interruptions and aligned reinforcement interruptions.

8. The kit as set forth in claim 7, further comprising a plurality of connectors to connect the at least one splice member and at least one of the plurality of reinforcement members with holes formed in the exterior surface of the tower structure.

9. The kit as set forth in claim 7, further comprising at least one cap member to overlie the at least one splice member and be connected to the tower structure through the holes formed in the exterior surface of the tower structure.

10. The kit as set forth in claim 9, where the at least one cap member retains the plurality of pins in the selected ones of the splice member interruptions aligned with the reinforcement interruptions.

11. The kit as set forth in claim 8, where the plurality of connectors comprise studs sized to mechanically connect the at least one splice member and at least one of the plurality of reinforcement members to the tower structure.

12. The kit as set forth in claim 8, where the plurality of connectors comprise blind bolts.

13. A tower reinforcement system comprising:
A plurality of reinforcement members each having a plurality of interruptions where non-adjacent ones of the plurality of interruptions form an index for connection locations to be formed in an exterior surface of the tower structure and others of the plurality of interruptions form a retention space sized to receive reinforcement pins;
At least one splice member having a plurality of splice member interruptions through the splice member where the splice member interruptions align with the plurality of interruptions in the reinforcement members, where non-adjacent ones of the plurality of splice member interruptions align with the non-adjacent ones of the plurality of interruptions in the reinforcement member and others of the splice member interruptions form a retention space sized to receive reinforcement pins;
A plurality of reinforcement pins sized to be received into selected ones of the splice member interruptions and interruptions in the reinforcement member;
At least one cap member having a number of cap member interruptions corresponding to a number of the non-adjacent ones of the plurality of splice member interruptions and aligned non-adjacent ones of the plurality of interruptions in the reinforcement member, where the cap member retains the reinforcement pins in the retention spaces; and
A plurality of connectors each connecting the cap member, the splice member, and the reinforcement member to the tower structure.

14. The system as set forth in claim 13, where the plurality of pins are retained between the exterior surface of the tower and the cap member.

15. The system as set forth in claim 13, where the plurality of connectors comprise bolts.

16. The system as set forth in claim 13, where the plurality of connectors comprise blind bolts.
